(19) United States
(12) Patent Application Publication
(10) Pub. No.: US 2006/0222057 A1
(43) Pub. Date: Oct. 5, 2006

(54) Method of correlating a sampled direct sequence spread spectrum signal with a locally provided replica

(75) Inventors: Saul R. Dooley, Horley (GB); Andrew T. Yule, East Grinstead (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/564,422

(22) PCT Filed: Jul. 12, 2004
(86) PCT No.: PCT/IB04/02278

§ 371 Date: Jan. 11, 2006

(30) Foreign Application Priority Data
Jul. 16, 2003 (GB) 0316608.9

(51) Int. Cl. H04B 1/00

(52) U.S. Cl. 375/150

(57) ABSTRACT

A method of correlating a sampled direct sequence spread spectrum signal with a locally provided replica signal containing a spreading code is disclosed together with a corresponding signal processor, receiver, computer-readable storage medium and computer program for the same. The method comprises the steps of combining the bit or bits of at least two signal samples of the received signal to form a first word; providing a second word containing bits corresponding to the replica signal; and executing one or more software based instructions to process the first and second words, especially in hardwired circuitry, in order to obtain a correlation value.

This invention relates to a method of correlating a sampled direct sequence spread spectrum signal with a locally provided replica signal containing a spreading code; and to a corresponding signal processor, receiver, computer-readable storage medium and computer program for the same.

It is well known to provide a NAVSTAR GPS receiver in which received GPS spread spectrum signals are repeatedly correlated with locally generated replica signals containing spreading codes in order to despread the received GPS signals. As the spread spectrum codes in received GPS signals are likely to have a different code phase to those of the replica signals and also a different frequency due to Doppler shift between the receiver and orbiting satellites, a two dimensional replica code phase and frequency phase sweep is normally employed whereby such a sweep will eventually result in the spread spectrum codes in received GPS signals having the same frequency and code phase as those of the locally generated replica. This will result in a positive correlation, indicating acquisition, and the code phase and frequency of the GPS signals may be subsequently tracked and pseudorange and other information derived from the GPS signals from which the position of the receiver may be calculated using conventional navigation algorithms.

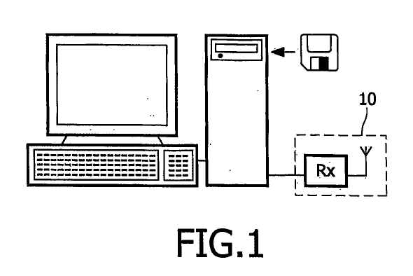

Virtually all current GPS receivers use application specific hardware to perform GPS signal acquisition, however, more recently, there has been development of software based GPS. For example, article “Real-time software radio architectures for GPS receivers” by Akos et al. (GPS World, July 2001) discloses GPS software receivers in which the GPS signal processing is accomplished by means of a programmable micro-processor or digital signal processor as opposed to analogue or discrete hardwires components. As illustrated in FIG. 2 of this article, a simplified “GPS software receiver” is provided consisting of a GPS antenna and GPS RF front-end section for GPS signal pre-processing (including filtering, amplification and frequency down-conversion) and analogue to digital conversion. The GPS signal samples outputted from the GPS RF front-end section can be fed in to a modern PC running appropriate GPS signal processing software to determine a position fix. The main disadvantage with software based GPS signal processing is that it is inherently slower than corresponding hardwired solutions.

In accordance with the present invention, there is provided a method of correlating a sampled direct sequence spread spectrum signal with a locally provided replica signal containing a spreading code and a corresponding signal processor, receiver, computer-readable storage medium and computer program for the same. The method comprises the steps of combining the bit or bits of at least two signal samples of the received signal to form a first word; providing a second word containing bits corresponding to the replica signal; and executing one or more software based instructions to process the first and second words, especially in hardwired circuitry, in order to obtain a correlation value.

The processing may include a word based exclusive-or (XOR) operation or its inverse and a summation of the results of that operation. Also, the first word may be formed by execution of a software based instruction.

In the event that each sample of the spread spectrum signal contains at least one magnitude bit and a sign bit, the first word may be formed by combining the magnitude bit or bits of at least two signal samples, a third word may be formed by combining the sign bit of at least two signal samples and one or more software based instructions may be executed to process the first, second and third words in order to obtain a correlation value.

With the present invention, the inventors have appreciated that most microprocessors are able to carry out fast, word based, hard-wired operations such as XOR operations using appropriate software hooks and use of these operations can significantly speed up spread spectrum signal acquisition.

The present invention will now be described, by way of example only, with reference to the accompanying figure which shows, schematically, a PC connected to a NAVSTAR GPS receiver device and operating in accordance with the present invention.

Referring to the accompanying figure, the PC is connected via a USB PC port and corresponding cable to the GPS receiver device 10 which consists of a GPS RF front-end section Rx and a GPS antenna. Whilst the device could have been a “dongle” type device thereby omitting the cable, the cable facilitates positioning of the GPS receiver device (including the antenna) in a prominent position, thereby increasing the chances of acquiring GPS signals. For example, one might place the GPS receiver device near a window if operating in doors.

When operative, the GPS receiver device receives NAVSTAR SPS GPS signals (which are direct sequence spread spectrum signals) through its antenna and pre-process them, typically by passive bandpass filtering in order to minimise out-of-band RF interference, preamplification, down conversion to an intermediate frequency (IF) and analogue to digital conversion. The resultant 1-bit GPS signal samples contain the IF signal which remains modulated, still containing all the information from the available satellites. The GPS signal samples are then outputted from the GPS receiver device via the USB link into PC memory (not shown).

Using appropriate GPS signal processing software according to the present invention, the GPS signal samples are processed as further described below so that GPS signals may acquired for the purpose of deriving pseudorange information from which the position of the PC can be determined using conventional navigation algorithms.

If we first consider conventional GPS signal acquisition in software: for a 1-bit stream of GPS IF signal samples, a correlation is typically done by using XOR operations applied to each bit of the GPS IF stream with a corresponding bit of both in-phase (I) and quadrature (Q) 1-bit bits of GPS replica signals (replicating the spreading code as modulated on both an I and Q phase IF carrier). For both I and Q phases, the XOR operation outputs are summed and the sums combined to produce a correlation output which is used to determine whether the signal has been acquired or not. It may help to consider this process in terms of the following pseudo-code which is repeated for each bit of the IF sample stream to generate the respective sums for the I and Q phases:
code=GenerateNextCodeBit( )
carrier=GenerateNextCarrierPhase( )
IFsample=GetNextIFsample( )
Isum=Isum+IFsample XOR (code XOR cos(carrier))
Qsum=Qsum+IFsample XOR (code XOR sin(carrier))

Note, a more sophisticated arrangement may be used if a complex GPS IF signal sample stream is used, but the principles are much the same.

In accordance with the present invention, for a 1-bit stream of GPS IF signal samples, consecutive 32 bit groups are combined to form consecutive words of the GPS IF signal sample stream which then have an XOR operation applied to them with a corresponding 32 bit words of both I and Q phase GPS replica signals. The XOR operation is performed in hardware pursuant to a software based instruction, e.g. on an ARM9 microprocessor which naturally operates on 32 bit words. For both I and Q phases, the word based, XOR operation outputs are summed and the sums combined to produce a correlation output which is used to determine whether the signal has been acquired or not.

If we compare the word based processing of the present invention with conventional bit based processing, there is an effective reduction in the number of XOR operations by a factor of 32 for the cost of having to carry out two bit counts and some simple packing operations. This in itself is worthwhile but in addition, in most practical software solutions, the IF data will be stored in packed words. Therefore, not only does the generation of the packed word have no cost, but the an unpacking cost needed if the conventional bit based processing from word based IF method is avoided.

It may help to consider this process in terms of the following pseudo-code which would which is repeated for each word of the IF sample stream generated in order to generate the respective sums for the I and Q phases:

for bit = 0 to 31 {
codeWord[bit] = GenerateCodeBit( )
phase = GenerateCarrierPhase( )
IcarrierWord[bit] = cos(phase)
QcarrierWord[bit] = sin(phase)
IFWord[bit]= GetNextIFsample( )
}
IWord = IFWord XOR codeWord XOR IcarrierWord
QWord = IFWord XOR codeWord XOR QcarrierWord
Isum = Isum + CountBitsSet(IWord)
Qsum = Qsum + CountBitsSet(QWord)

It is worth noting that variants of this approach could be used for multi-bit sampling, although the gains may be less. The specific case of 1.5 bit sampling (i.e. values of 1, 0, and −1) could clearly be supported by having separate sign and magnitude words and processing the sign word as a 1 bit value, but using magnitude word as a mask in the bit count operation.

The present invention has been illustrated in the context of a PC with software GPS capability, however, it is of course equally applicable to other apparatus able to support GPS signal processing software, and to which a GPS receiver device according to the present invention can be connected. For example, the invention may be employed with mobile devices such as laptop PCs, and PDAs; or generally stationary objects such as a TVs or TV set-top boxes. Furthermore, the invention is equally applicable to non-GPS direct sequence spread spectrum signal acquisition including when employed for mobile telephony.

1. A method of correlating a sampled direct sequence spread spectrum signal with a locally provided replica signal containing a spreading code comprising the steps of:
combining the bit or bits of at least two signal samples of the received signal to form a first word;
providing a second word containing bits corresponding to the replica signal; and
executing one or more software based instructions to process the first and second words in order to obtain a correlation value.

2. A method according to claim 1 wherein the processing of the first and second words is done using hardwired circuitry.

3. A method according to claim 1 wherein the processing of the first and second words includes a word based XOR operation or its inverse and a summation of the results of that operation.

4. A method according to claim 1 wherein a software based instruction is executed to form the first word.

5. A method according to claim 1 wherein each sample of the spread spectrum signal contains at least one magnitude bit and a sign bit; wherein the first word is formed by combining the magnitude bit or bits of at least two signal samples; wherein a third word is formed by combining the sign bit of at least two signal samples; and wherein one or more software based instructions are executed to process the first, second and third words in order to obtain a correlation value.

6. A signal processor configured for correlating a sampled direct sequence spread spectrum signal with a locally provided replica signal containing a spreading code by combining the bit or bits of at least two signal samples of the received signal to form a first word, providing a second word containing bits corresponding to the replica signal, and executing one or more software based instructions to process the first and second words in order to obtain a correlation value.

7. A signal processor according to claim 6 wherein the processing of the first and second words is done using hardwired circuitry.

8. A signal processor according to claim 6 wherein the processing of the first and second words includes a word based XOR operation or its inverse and a summation of the results of that operation.

9. A signal processor according to claim 6 wherein a software based instruction is executed to form the first word.

10. A signal processor according to claim 6 wherein each sample of the spread spectrum signal contains at least one magnitude bit and a sign bit; wherein the first word is formed by combining the magnitude bit or bits of at least two signal samples; wherein a third word is formed by combining the sign bit of at least two signal samples; and wherein one or more software based instructions are executed to process the first, second and third words in order to obtain a correlation value.

11. A direct sequence spread spectrum signal receiver comprising an antenna and an RF front-end including an analogue to digital converter for receiving spread spectrum signals and outputting corresponding signal samples; and a signal processor according to claim 6.

12. A computer-readable storage medium having recorded thereon data containing instructions for performing a method according to claim 1.

13. A computer program comprising instructions for performing a method according to claim 1.
